(19) United States
(12) Patent Application Publication
(10) Pub. No.: US 2010/0250628 A1
(43) Pub. Date: Sep. 30, 2010

(54) Identity Confidence Framework

(75) Inventors: Samir Nanavati, Herndon, VA (US); David Coleman, McLean, VA (US); Rajkumar Nanavati, New York, NY (US)

Correspondence Address: KATTEN MUCHIN ROSENMAN LLP, 575 MADISON AVENUE, NEW YORK, NY, 10022-2585, US

(73) Assignee: FUSIONARC, INC., New York, NY (US)

(21) Appl. No.: 12/715,750

(22) Filed: Mar. 2, 2010

Related U.S. Application Data
(60) Provisional application No. 61/157,798, filed on Mar. 5, 2009.

(51) Int. Cl. G06F 17/30

(52) U.S. Cl. 707/812; 707/E17.005; 707/E17.009

(57) ABSTRACT

An Identity Confidence Framework is a method for determining the confidence that each of various identity elements pertain to the same person.

### CROSS-REFERENCE TO RELATED APPLICATIONS

This application is based upon and claims the benefit of priority of the prior U.S. Provisional Application No. 61/157,798, filed Mar. 5, 2009, the entire contents of which are incorporated herein by reference.

### FIELD OF THE INVENTION

The present invention relates to the field of identity management and biometric identification technologies.

### BACKGROUND OF THE INVENTION

Authorities are often required to determine a person's identity before performing a civic or commercial task. This process of identification is generally performed to establish a link between the person and various public or private records that describe them. For instance, a law enforcement officer may link a person to their driver's license, which in turn provides the information to link the driver's license to driving rights and privileges. Alternatively, the law enforcement officer may link a person to a biometric record in FBI's Integrated Automated Fingerprint Identification System (IAFIS), which is in turn linked to a criminal record.

In order to determine if any important identity elements such as criminal records exists, the investigator must determine the confidence with which each successive identity element is assumed to be authentic and pertaining to the subject at hand. In the previous example, the officers creating the initial record in the criminal record system must be confident that the identification elements used to enroll subjects were authentic, and the officer must be confident that the identification presented by the subject is authentic. This information is not immediately available to the officer, as the authenticity of a driver's license is contingent on the authenticity of breeder documents (e.g. Birth Certificate, Social Security Card) that are no longer available for inspection. The Identity Confidence Framework provides a structure and method for determining the confidence that a given identity element corresponds to a given subject.

### BRIEF DESCRIPTION OF THE DRAWINGS

FIG. 1 is a graph representing an Identity Confidence Framework; and

FIG. 2 is a graph representing an example of an Identity Confidence Framework.

### SUMMARY OF THE INVENTION

A person's identity can be the defined as the set of all identity elements that pertain to them. An identity element is any electronic or physical artifact relating to them as an individual. Identity elements may be owned and possessed by the subject being identified, a government entity, a commercial entity, or a third party. Identity elements may be stored on information systems, made available through networks, or portable. Identity elements may be comprised of data on an information system or physical objects which may be electronic or inert.

Examples of identity elements include:

Centralized elements such as biometric records; tax records; property records; motor vehicle records; pet registration records; sex offender registries; travel records; bank records; social networking profiles and accounts; forum postings and accounts; blogs and blog entries; news archives; CRM databases; Distributed elements such as drivers licenses; passports, visas, and other travel documents; library cards; birth certificates; social security cards; vehicle identification transponders; business cards; credit cards; debit cards; customer loyalty cards; and mobile phones.

An observer can usually only view a subset of all the elements for any given person. The Identity Confidence Framework is a method for organizing and evaluating identity elements that potentially pertain to a given person. Additionally, the ICF allows identity elements to be assigned a confidence score for any person describing the model's confidence that the element pertains to that person. A set of ICF graphs can be used to determine characteristic patterns of identity for the set of included persons. A learning algorithm trained on various categories of graphs can assign identities represented by newly formed or partial graphs to the previously defined categories.

As a preferred method, the Identity Confidence Framework is stored on a computer system in a structured format defining the relationship between each identity element, such as a graph with weighted nodes and edges. The implementation of this logical data structure may take many forms, including a database, a matrix, or a series of files.

If the ICF is represented as graph, a known person corresponds to a single node (subject-node). Each discovered identity element corresponds to another node (element-node) in the graph. The element-node is assigned a weight corresponding to the confidence that the identity element is authentic. The existence of some types of element-nodes may imply the existence of other nodes. For instance, the existence of a driver's license implies the existence of 2 breeder documents, such as passports, social security cards, or birth certificates.

An Identity Link is a relationship between two identity elements, such as between a physical driver's license and its corresponding DMV record, or between a driver's license and the birth certificate that was used to obtain it. An Identity Link is represented on the graph by an edge (link-edge) between two element-nodes. The link-edge is assigned a weight corresponding to the confidence that the two identity elements pertain to the same person.

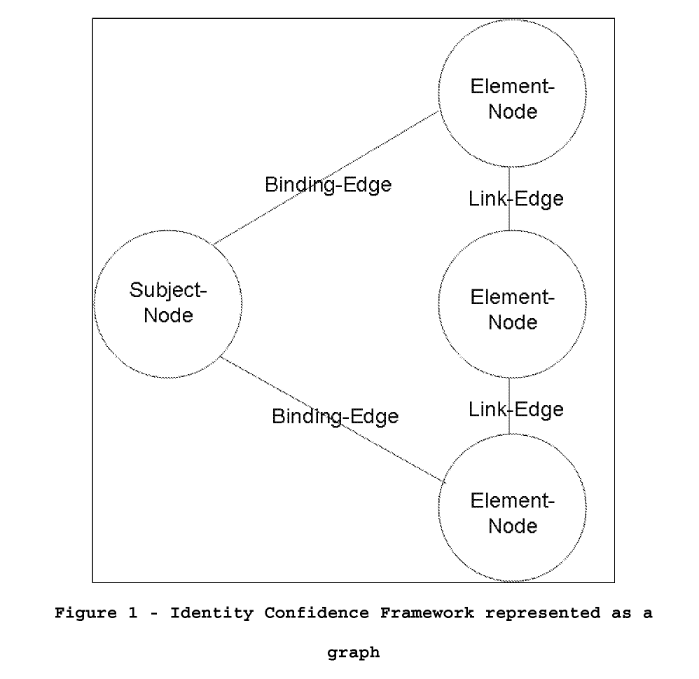

An Identity Binding is a relationship between an identity element and the subject in question. An Identity Binding is represented in the graph by an edge (binding-edge) between the subject-node and an element-node. This edge is assigned a weight corresponding to the confidence that the identity element had been originally assigned to the person. The ICF in graph form is shown in FIG. 1.

For each element-node, an overall confidence that it applies to a given person may be determined by considering the link-edge, binding-edge, and element-node weights between that element-node and the subject-node. Similarly, a confidence that two element-nodes are related to the same identity may be determined by considering the link-edge, binding-edge, and element-node weights between them.

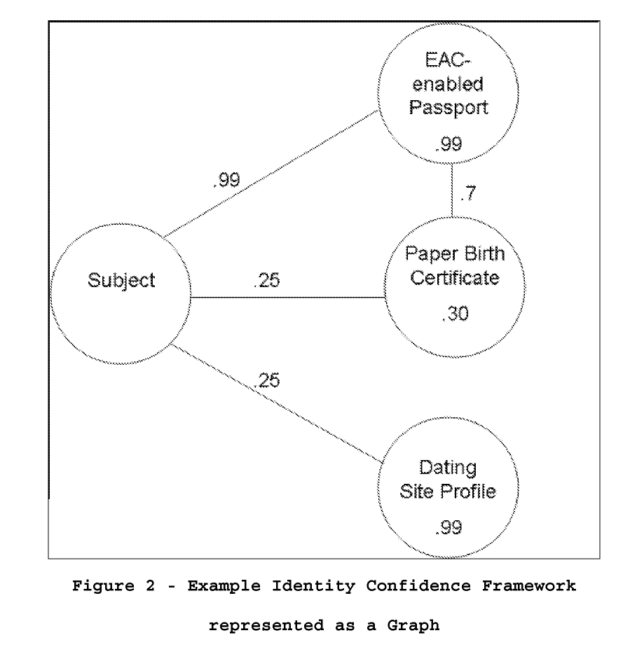

A high confidence that an element pertains to a specific person does not necessarily imply that their identity is well understood. A person's name is a characteristic of their identity elements, not their person. For example, a high confidence link between a passport with a photograph and the person holding it only implies that the license was originally issued to the person holding it. Confidence of the person's name would be determined by examining the links to other elements and their respective authenticity confidence levels, eventually determining the confidence that the license corresponds to an authentic birth or change of name record. This is shown in graph form in FIG. 2.

What is claimed is:

1. A method of storing identity elements suspected of belonging to a subject in a structured data model.

2. The method of claim 1, where the structured data model is a graph.

3. The method of claim 2, where the graph is an undirected graph.

4. The method of claim 3, where a single node (subject-node) is assigned to each subject.

5. The method of claim 4, where other nodes (element-nodes) are assigned to identity elements and are assigned a weight corresponding to confidence in the element's authenticity.

6. The method of claim 5, where each edge (binding-edge) between an element-node and a subject-node is assigned a weight corresponding to confidence that the element pertains to the given subject.

7. The method of claim 6, where each edge (link-edge) between an element-node and another element-node is assigned a weight corresponding to confidence that the two elements pertain to the same subject.

8. The method of claim 7, where an overall confidence is computed for each identity-element, based on other edge and node weightings in the graph.

9. The method of claim 2, where the graph is a directed graph.

10. The method of claim 9, where a single node (subject-node) is assigned to the subject.

11. The method of claim 10, where other nodes (element-node) are assigned to identity elements.

12. The method of claim 11, where each edge (binding-edge) between an element-node and a subject-node is assigned a weight corresponding to confidence that the element pertains to the given subject.

13. The method of claim 12, where each edge (link-edge) between an element-node and another element-node is assigned a weight corresponding to confidence that the two elements pertain to the same subject and that the destination element is authentic.

14. The method of claim 13, where each for each link-edge (x,y) between element-node x and element-node y there is a corresponding edge (y,x).

15. The method of claim 14, where an overall confidence is computed for each identity-element, based on edge weightings in the graph.

16. The method of claim 1, where the structured data model is selected from the set of matrix, list, database, database table, or file system.

17. The method of claim 1, where the structured data model is a non-graph object model.
